(19) United States
(12) Patent Application Publication
(10) Pub. No.: US 2008/0038303 A1
(43) Pub. Date: Feb. 14, 2008

(54) Novel Solid Compositions for Disinfected Water

(76) Inventors: Theodor Morel Fishler, Haifa (IL); David Feldman, Haifa (IL)

Correspondence Address: Kevin D McCarthy;Roach Brown McCarthy & Gruber, 420 Main Street, 1620 Liberty Building, Buffalo, NY, 14202, US

(21) Appl. No.: 11/631,922

(22) PCT Filed:
(86) PCT No.: PCT/IL05/00723

(30) Foreign Application Priority Data
Jul. 8, 2004 (IL) 162934

(51) Int. Cl. A01N 25/08; A01N 25/34; A01N 43/50; A01N 43/66

(52) U.S. Cl. 424/405; 514/241; 514/389

(57) ABSTRACT

The present invention provides a method for the preparation of water-sanitizing solid, shaped compositions, said method comprising the steps of: mixing a halogenated 5,5-dimethylhydantoin compound or mixture of compounds with a chlorine biocide compound and compacting the mixture into a final single solid composition, by applying a pressing force sufficient to produce granules and a physically strong, solid, shaped body.

### FIELD OF THE INVENTION

The present invention relates to disinfecting water systems. More particularly, the present invention relates to bromine and chlorine containing organic compounds for disinfecting water systems.

### BACKGROUND

Various water systems provide suitable environment for the development of a plethora of microorganisms and for the accumulation of different organic and inorganic compounds, thereby rendering water circulation systems and supply reservoirs essentially contaminated, where those systems may also act as disease spreading vectors. Disinfecting of water and biofouling neutralization as well as the neutralization of other organic and inorganic substances present in water is generally addressed by the incorporation of relatively small amounts of biocides reacting with the microorganisms, debris of microorganisms and other compounds, decomposing them into water-soluble or volatile products and rendering the water system clean or at least hygienically controllable.

One group of well-known biocides encompasses halo-donor organic compounds, and most particularly, halo-donor hydantoin based biocides. Compounds of this group, 1-bromo-3-chloro-5,5-dialkylhydantoin, 1-chloro-3-bromo-5,5-dialkylhydantoin and dibromo-dialkyl-hydantoin, particularly those where alkyl is methyl (BCDMH and DBDMH) are widely used in the control of microbial and algae growth and in various water treatment applications such as industrial cooling water systems, waste water treatment systems, swimming pool disinfection, etc. and is very effective in killing many kinds of bacteria, algae, and fungi even at concentrations as low as only a few ppm. Other known and extensively used biocidal compounds possessing disinfection capabilities are trichloroisocyanuric acid or TCCA and sodium dichloroisocyanurate or NaDCC. The biocidal activity for BCDMH, DBDMH, TCCA and NaDCC is made viable through their hydrolysis in aqueous medium, release of a halogen and the subsequent formation of a halogen containing molecule, i.e. a hypohalous acid—HOX (X standing for halogen), which can either be hypobromous or hypochlorous acid.

The superiority of hypobromous acid disinfecting activity over that of hypochlorous acid has long been established, thereby rendering BCDMH and DBDMH products more attractive than many of its competitors. Other qualities of this material include better hydrolysis in water, better activity against biological contaminants especially in high (basic) pH environments with less volatility and odor.

The main drawback, so far encountered, of BCDMH, DBDMH and of similar compounds is their difficulty in being compacted into chemically stable and physically strong tablets. Therefore there is an increasing need for incorporating different, biologically inactive binding materials together with the active material, thereby decreasing the sanitizing efficacy of the tablets. As a result, more of the product should be used in order to achieve the required biocide concentration in the water which, concomitantly, would result in the binders accumulating in the water, thereby decreasing its quality.

On the other side, the high capability of chlorinated biocides, like N,N′,N″-trichloroisocyanuric acid (TCCA) and/or sodium dichloroisocyanurate (NaDCC), to be pressed into strong solid compositions without difficulty is well known to those skilled in the art.

U.S. Pat. No. 4,532,330, U.S. Pat. No. 4,560,766, U.S. Pat. No. 4,654,424, U.S. Pat. No. 4,677,130, U.S. Pat. No. 4,745,189 and U.S. Pat. No. 5,565,576 disclose various additives such as alkali or alkali-earth salts or hydroxides that play the role of binders, or of various substrates such as ethyl-methyl-hydantoin or propyl-methyl hydantoin that are halogenated and mixed with 1,3-dihalo-5,5-dimethylhydantoin.

U.S. Pat. No. 6,495,698 discloses a method for preparing large particle size BCDMH that can be pressed into strong solid compositions, i.e. granules, without any binder. Such solid compositions are efficient for sanitizing plants and processes, but fail to be pressed into sufficiently strong tablets, while pucks, i.e. tablets or blocks larger than 20-30 g, cannot be pressed at all. In addition they are found to be not 100% pure BCDMH, containing other halogenated 5,5-dimethylhydantoin compounds, and therefore are not as effective as the pure equivalent amount of BCDMH would be, and require tuning and adjusting the tabletting instrumentation for every type of mixture compacted. This also indicates the still unresolved difficulty in the compaction into high-efficacy tablets of pure or at least of high-concentration BCDMH mixtures.

An existing solution for the production of strong solid compositions of BCDMH-containing sanitizers is its mixing with halogenated, preferably chlorinated, derivatives of substituted alkylated hydantoins other than 5,5-dimethylhydantoin. Such mixtures contain 51% BCDMH, but also incorporate compaction aids (sometimes in excess of 15%) resulting in a relatively low halogen content i.e. about 18% based on the bromine with respect to 29-31% in BCDMH. This means that larger amounts of product should be used in sanitization of water bodies with correspondingly higher organic and inorganic residuals. Moreover, the hydantoinic substrates, suitable for the preparation of substituted hydantoins, are not commonly found on the market, and their price is significantly higher than the price of 5,5-dimethylhydantoin resulting in cost increase of the tabletted product.

It would therefore be desirable to provide halogenated 5,5-dimethylhydantoin, mixtures of 1-bromo-3-chloro-; 1-chloro-3-bromo; 1,3-dibromo- and 1,3-dichloro-5,5-dimethylhydantoin as resulting from the halogenation process, or dibromo-5,5-dimethylhydantoin (DBDMH), mixed only with chlorine biocide compounds in various proportions, which can increase significantly the tabletting capability and the shaped solid body product's strength without decreasing (actually increasing) the available halogen content while preserving a biocide efficacy higher than the bromine-containing biocide.

It is therefore, an object of the present invention to provide a method for the preparation of physically strong, high-efficacy water sanitizing solid, shaped compositions.

Throughout this specification and claims, unless otherwise specified, the terms “solid composition” or “shaped compositions” includes, inter alia, briquettes, wafers, tablets and sticks and the like in various dimensions and weights, containing halogenated 5,5-dimethylhydantoins and chlorine biocide compounds. Additionally, throughout this specification the terms “shaped body” (or “bodies”) and “shaped compositions” are used interchangeably.

It is another object of the present invention to provide a method of preparing physically strong and high-efficacy water-sanitizing, solid, shaped compositions of BCDMH or of DBDMH, and trichloroisocyanuric acid (TCCA) or sodium dichloroisocyanurate (NaDCC).

Still another object of the present invention is to provide granules, as well as, solid, shaped compositions prepared by this method.

Still another object of the present invention is to provide compacted shaped bodies in which TCCA, NaDCC or mixtures thereof serves both as a compacting aid and as a sanitizer.

Still another object of the present invention is to provide an improved biocidal activity of the product by increasing the total active halogen content in the compacted solid composition.

It is yet another object of the invention to provide improved solid compositions, both granular and shaped, useful for the disinfection of water such as industrial water, waste water, pulp & paper industry water, cooling towers, pools and spas, institutional and domestic applications and the like.

This and other objects of the invention will become apparent as the description proceeds.

### SUMMARY OF THE INVENTION

In one aspect, the invention relates to a method for the preparation of water-sanitizing solid compositions, said method comprising the steps of: mixing a halogenated 5,5-dimethylhydantoin compound with a chlorine biocide compound and compacting the mixture into granules and/or a final single solid composition, by applying a compressive force sufficient to produce granules and a physically strong, solid, shaped body.

According to a preferred embodiment of the invention the halogenated 5,5-dimethylhydantoin compound or mixture of compounds is the result of the halogenation process of 5,5-dimethylhydantoin. Preferably—but not limitatively—the halogenated 5,5-dimethylhydantoin compound is selected from 1-bromo-3-chloro-5,5-dimethylhydantoin, 1-chloro-3-bromo-5,5-dimethylhydantoin, 1,3-dibromo-5,5-dimethylhydantoin (DBDMH) or mixtures of 1-bromo-3-chloro-5,5-dimethylhydantoin and 1-chloro-3-bromo-5,5-dimethylhydantoin and 1,3-dibromo-5,5-dimethylhydantoin and 1,3-dichloro-5,5-dimethylhydantoin or any combination thereof.

Illustrative examples of chlorine biocide compound are trichloroisocyanuric acid (TCCA) and sodium dichloroisocyanurate (NaDCC) or mixtures thereof. The content of chlorine biocide compound in the final compacted granular or shaped product is typically between about 10% and about 80% by weight, preferably between about 20% and about 40% by weight.

The weight of the final solid, shaped product may vary over a wide range and is preferably between about 10 and 300 grams, more preferably between about 20 and 100 grams.

The invention also relates to a method for the preparation of water-sanitizing tablets, comprising the steps of mixing halogenated 5,5-dimethylhydantoin such as bromochlorodimethylhydantoin (BCDMH) or dibromodimethylhydantoin (DBDMH) with trichloroisocyanuric acid (TCCA) or with sodium dichloroisocyanurate (NaDCC), or mixtures thereof, and compacting the mixture into a final single shaped body by applying a press force sufficient to produce said body with a breaking strength of 16 lbs or greater. Representative examples of suitable breaking strength tests are in the range of 16 lbs to 85 lbs wherein the content of said TCCA or said NaDCC is in the range of between about 10% and about 80%, most preferably in the range of between about 20% and about 40% by weight.

According to a preferred embodiment of the invention there is provided a method for the preparation of water-sanitizing solid, shaped compositions having a weight of about 20 grams or less. Said method comprises the steps of mixing bromochlorodimethylhydantoin (BCDMH) or dibromodimethylhydantoin (DBDMH) with trichloroisocyanuric acid (TCCA) or with sodium dichloroisocyanurate (NaDCC), or mixture thereof, and compacting the mixture into a final single shaped body by applying a press force sufficient to attain a breaking strength above 16 lbs. Representative examples of suitable breaking strength tests are in the range of 65 lbs to 80 lbs, wherein the content of said TCCA or said NaDCC (or mixture thereof) is in the range of between about 10% and about 80%, most preferably in the range of between about 20% and about 40% by weight.

According to another preferred embodiment of the invention there is provided a single compacted water-sanitizing solid, shaped bodies containing a mixture of halogenated 5,5-dimethylhydantoin compounds and a chlorine biocide compound. The halogenated 5,5-dimethylhydantoin is preferably selected from 1-bromo-3-chloro-5,5-dimethylhydantoin, 1-chloro-3-bromo-5,5-dimethylhydantoin, 1,3-dibromo-5,5-dimethylhydantoin (DBDMH) or mixtures of 1-bromo-3-chloro-5,5-dimethylhydantoin and 1-chloro-3-bromo-5,5-dimethylhydantoin and 1,3 dibromo-5,5-dimethylhydantoin and 1,3-dichloro-5,5-dimethylhydantoin or any combination thereof.

According to a preferred embodiment of the invention the halogenated 5,5-dimethylhydantoin compounds are the products of the halogenation process of 5,5-dimethylhydantoin and according to another preferred embodiment of the invention the chlorine biocide compounds are selected from trichloroisocyanuric acid (TCCA) or sodium dichloroisocyanurate (NaDCC) or mixtures thereof.

An example of a preferred solid, shaped body made according to the invention is a single compacted tablet containing a mixture of bromochlorodimethylhydantoin (BCDMH) and trichloroisocyanuric acid (TCCA) or sodium dichloroisocyanurate (NaDCC), said BCDMH content in said tablet being about 67.5 wt %, and said TCCA or said NaDCC content in said tablet being about 32.5 wt %, said tablet weight being about 100 grams or more and said tablet's breaking strength being in the range of 16 lbs to 85 lbs.

Another example of a preferred solid, shaped composition made according to the invention is a single compacted tablet containing a mixture of bromochlorodimethylhydantoin (BCDMH) and trichloroisocyanuric acid (TCCA) or sodium dichloroisocyanurate (NaDCC) or mixture thereof, wherein: the BCDMH content in said tablet is about 80 wt %, the TCCA or NaDCC content in said tablet is about 20 wt %, the weight of the tablet is about 100 grams or more and the breaking strength of the tablet is in the range of 16 lbs to 85 lbs.

A further example of a preferred solid, shaped composition made according to the invention is a single compacted tablet containing a mixture of 1-bromo-3-chloro-5,5-dimethylhydantoin (BCDMH) and trichloroisocyanuric acid (TCCA) or sodium dichloroisocyanurate (NaDCC), wherein the BCDMH content in said tablet is about 70 wt %, the TCCA or NaDCC content in said tablet is about 30 wt %, and the tablet has an oxidizing power as chlorine of about 67% for TCCA and of about 57%, for NaDCC. Still another example of a preferred solid, shaped composition made according to the invention is a single compacted tablet containing a mixture of 1,3-dibromo-5,5-dimethylhydantoin (DBDMH) and trichloroisocyanuric acid (TCCA) or sodium dichloroisocyanurate (NaDCC), wherein the DBDMH content in said tablet is about 70 wt %, the TCCA or NaDCC content in said tablet is about 30 wt %, and said tablet has an oxidizing power as chlorine of about 62% for TCCA and of about 51% for NaDCC.

The invention also encompasses the use of a granular or solid, shaped compositions of the invention for the disinfection of aqueous media. Illustrative examples of aqueous media that can be disinfected according to the invention include industrial water, waste water, pulp & paper industry process water, cooling towers, swimming pools, spas and institutional and domestic applications and the like.

### BRIEF DESCRIPTION OF THE DRAWING

FIG. 1 illustrates a Rimac Tester used to determine the breaking strength of solid compositions described in the examples to follow.

### DETAILED DESCRIPTION OF THE INVENTION

The present invention provides a method for preparing granules and physically strong, biocidally effective, solid, shaped bodies and products thereof.

Some Reference Examples summarized in Tables I and II below illustrate the current performances of related prior art products containing either BCDMH alone or in combination with different additives, where such additives function as binders or tabletting aids. It is evident that BCDMH has certain physical properties that are not conducive to the production of physically strong, solid shaped bodies under regular conditions but require often the presence of different supporting additives, such as boric acid. However, the addition of boric acid (Table II) does not guarantee a physically strong product even when applying higher pressures during the tabletting process. Experiments carried out for the preparation of 100 g tablets of BCDMH showed that their breaking strength cannot be improved by increasing the applied force.

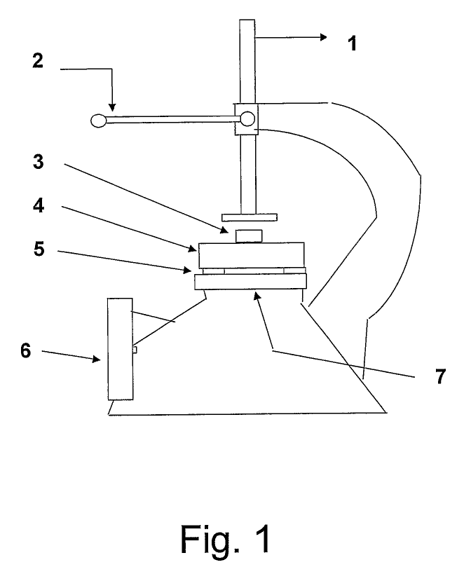

Throughout this description breaking strength is measured according to the following testing method. This method is applicable for measuring the breaking compressive strength of compacted solid products. A tablet or stick is positioned in a particular manner in a Rimac Tester (FIG. 1). Pressure is applied to the sample and a reading is taken after the sample has been fractured or broken. The pound (or kilogram) reading representing the force required to break the solid body, is dictated on a display gauge by an arrow attached to an internal tension spring.

The elements of the Rimac Tester are indicated by the following numerals:
1—Upper Ram;
2—Rimac Upper Ram Compression Handle
3—Breaker Bar
4—Tablet
5—Tablet Support Frame
6—Rimac Tester Display Gauge
7—Rimac Lower Support Platform

The results are presented in Table I:

TABLE I
100% BCDMH, 100 g Pucks Prepared at Various Pressures

| | Pressing Force | Breaking | |
|---|---|---|---|
| Puck # | (lbs.) | Strengh (lbs) | Appearance |
| #1 | 20,000 | 10 | Poor, crumbly |
| #2 | 25,000 | 16 → 17 | Poor, crumbly |
| #3 | 30,000 | 18 | Rough & poor |

Table II below, as mentioned above, shows no significant effect of the incorporation of additives, commonly used for increasing the BCDMH tablet characteristics.

TABLE II
100 g pucks from BCDMH/Boric Acid (83.3/16.7
by wt.) mix at various pressures

| | Pressing Force | Breaking | |
|---|---|---|---|
| Tablet | (lbs.) | Strength (lbs) | Appearance |
| #1 | 20,000 | 8 | Smooth, very poor |
| #2 (2 Tablets) | 25,000 | 16, 16 | Smooth, poor, crumbly |
| #3 (2 Tablets) | 30,000 | 10, 12 | Smooth, poor, |
| | | | crumbly, best |

Addition of 2% Mg stearate, a common lubricant and tabletting aid, gave very poor tablets with only 4-6 lbs strength.

A mechanically strong (70 lbs) 100 g puck is commercialized under the name Clorox Brand Automatic Toilet Bowl Tablets, however, with a concentration of only 51% BCDMH:

| | |
|---|---|
| 1-bromo-3-chloro-5,5-dimethylhydantoin | 51% |
| 1,3-dichloro-5,5-dimethylhydantoin | 23.3% |
| 1,3-dichloro-5-ethyl-5-methylhydantoin | 9.0% |
| other ingredients (inerts) | 16.7% |

According to the present invention, addition of TCCA and/or NaDCC (sodium dichloroisocyanurate) or mixtures thereof to BCDMH improves significantly the properties of tableted products. The use of TCCA is highly preferred because of its very high available halogen concentration (over 90%).

Table III herein below demonstrates one preferred composition of a mixture of 70% BCDMH (containing 57.8% active halogen as chlorine) and 30% TCCA (containing 90% active chlorine) or a mixture of 70% DBDMH (containing 49.7% active halogen as chlorine) with 30% TCCA (containing 90% active chlorine). One can clearly see that these compositions have the following superior active halogen content in comparison with other commercial products:

TABLE III

| | Oxidizing Power |
|---|---|
| | (as Chlorine) % |
| Dantobrom* | 60.6 |
| BCDMH | 57.8 |
| BCDMH/TCCA | 67 |
| 70/30 | |
| DBDMH/TCCA | 62 |
| 70/30 | |

*TM of Lonza: Halogenated mixture of alkylated hydantoins

Since the concentration of active halogen required for sanitation of water is 1-5 ppm, it is obvious that using products with a higher active halogen content will result in lower amounts consumed for sanitation over the same period of time. This has an obvious economic impact for the users, which is enhanced by the lower cost of such products in view of the significantly lower price of chlorinated cyanuric acid derivatives with respect to BCDMH.

As an additional bonus, the strength of 20 g tablets prepared by this method is significantly higher than that of similar tablets prepared from BCDMH, as is shown in Table IV below:

TABLE IV

| | Size | | |
|---|---|---|---|
| | 100 g | 20 g | |
| Tablet | Breaking Strength (lbs) | | Aspect |
| BCDMH | 12-17 | 23-29 | Good. Edges intact. |
| | | | Smooth surface. Some |
| | | | capping. |
| BCDMH/TCCA | 20.5-24.5 | 75-80 | Good. Smooth surface |
| (70/30) | | | but moonscaping. No |
| | | | capping. |
| DBDMH/TCCA | 18.5-22.8 | 65-70 | Good. Smooth surface |
| (70/30) | | | |

It is also noted that an improved breaking strength is achieved also for 100 g tablets containing the compositions described in the above Table IV, and that the other physical features of both weights are better than 100% BCDMH.

Various proportions of TCCA and halogenated dimethylhydantoin compounds (HDMH) can be used, as well as of NaDCC, according to the requirements. Mixtures of HDMH and of TCCA, where the TCCA content is from 10 to 80%, are suitable. Preferably, the TCCA content is in the range of 20 and 40%.

Examples of tablet compositions and characteristics are given in Table V below:

TABLE V

| | Press | Breaking | |
|---|---|---|---|
| | Force, | Strength, | |
| Sanitizer | (Klbs.) | (lbs) | Appearance |
| BCDMH* | 30 | 12-13 | Granular, crumbly |
| | 35 | 14-15 | Smoother, shape better, |
| | | | crumbly |
| | 40 | 16-18 | Still smoother, slightly |
| | | | crumbly |
| | 50 | 16-18 | Shape OK but broke on |
| | | | handling |
| BCDMH/TCCA** | 30 | 24-25 | Well shaped, slightly crumbly |
| | 35 | 22-23 | Well shaped, smooth, slightly |
| | | | crumbly |
| | 40 | 20-21 | Smooth, good shape, slightly |
| | | | crumbly |
| | 50 | 22 | Best looking, slightly crumbly |
| BCDMH/TCCA*** | 30 | 20-21 | Shape OK, crumbly |
| | 35 | 16 | Shape OK, slightly crumbly |
| | 40 | 21-22 | Smooth, not crumbly |
| | 50 | 22-24 | Best, not crumbly |

*BCDMH containing 1-2% NaCl;
**BCDMH 67.5%/TCCA 32.5%;
***BCDMH 80%/TCCA 20%.

Table V demonstrates that when employing pressure force in the range of 30 to 50 Klbs tablet strength is improved, relative to 100% BCDMH, for both BCDMH/TCCA proportions examined.

While examples of the invention have been described for purposes of illustration, it will be apparent that many modifications, variations and adaptations can be carried out by persons skilled in the art, without exceeding the scope of the claims.

1. A method for the preparation of water-sanitizing solid, shaped compositions, said method comprising the steps of: mixing a halogenated 5,5-dimethylhydantoin compound or mixture of compounds with a chlorine biocide compound and compacting the mixture into a final single solid composition, by applying a pressing force sufficient to produce granules and a physically strong, solid, shaped body.

2. The method of claim 1, wherein the halogenated 5,5-dimethylhydantoin compound or mixture of compounds is the result of the halogenation process of 5,5-dimethylhydantoin.

3. The method of claim 1, wherein the halogenated 5,5-dimethylhydantoin compound is selected from 1-bromo-3-chloro-5,5-dimethylhydantoin, 1-chloro-3-bromo-5,5-dimethylhydantoin, 1,3-dibromo-5,5-dimethylhydantoin (DBDMH) or mixtures of 1-bromo-3-chloro-5,5-dimethylhydantoin and 1-chloro-3-bromo-5,5-dimethylhydantoin and 1,3-dibromo-5,5-dimethylhydantoin and 1,3-dichloro-5,5-dimethylhydantoin or any combination thereof.

4. The method of claim 1, wherein the chlorine biocide compound is trichloroisocyanuric acid (TCCA) or sodium dichloroisocyanurate (NaDCC) or mixtures thereof.

5. The method of claim 1, wherein the chlorine biocide compound content of the final compacted granule or solid, shaped body is between about 10% and about 80% by weight.

6. The method of claim 4, wherein the chlorine biocide compound content is between about 20% and about 40% by weight.

7. The method of claim 1, wherein the weight of the solid, shaped body is between about 10 and 300 grams.

8. The method of claim 7, wherein the weight of the solid, shaped body is between about 20 and 100 grams.

9. The method of claim 4, wherein the content of TCCA or of NaDCC or of their mixture in the final solid, shaped body, is between about 10% and about 80%, most preferably between about 20% and about 40% by weight.

10. A method for the preparation of water-sanitizing, solid, shaped bodies comprising the steps of mixing a halogenated 5,5-dimethylhydantoin with trichloroisocyanuric acid (TCCA) or with sodium dichloroisocyanurate (NaDCC) or with mixtures thereof and compacting the mixture into a final solid, shaped body by applying a press force sufficient to produce a solid, shaped product with a breaking strength above about 16 lbs wherein the content of said TCCA or said NaDCC or mixtures thereof is in the range of about 10% and about 80%, most preferably in the range of about 20% and about 40% by weight.

11. A method according to claim 10, wherein the halogenated 5,5-dimethylhydantoin is bromochlorodimethylhydantoin (BCDMH) or dibromodimethylhydantoin (DBDMH).

12. A method according to claim 10, wherein the weight of the solid, shaped body is between about 10 and 300 grams.

13. The method of claim 12, wherein the weight of the final solid, shaped body is between about 20 and 100 grams.

14. A compacted, water-sanitizing, solid, shaped composition or body containing a mixture of halogenated 5,5-dimethylhydantoin compounds and a chlorine biocide compound.

15. The solid, shaped body of claim 14, wherein said halogenated 5,5-dimethylhydantoin is selected from 1-bromo-3-chloro-5,5-dimethylhydantoin, 1-chloro-3-bromo-5,5-dimethylhydantoin, 1,3-dibromo-5,5-dimethylhydantoin (DBDMH) or mixtures of 1-bromo-3-chloro-5,5-dimethylhydantoin and 1-chloro-3-bromo-5,5-dimethylhydantoin and 1,3-dibromo-5,5-dimethylhydantoin and 1,3-dichloro-5,5-dimethylhydantoin or any combination thereof.

16. The solid, shaped body of claim 15, wherein the halogenated 5,5-dimethylhydantoin compounds are the products of the halogenation process of 5,5-dimethylhydantoin.

17. The solid, shaped body of claim 15, wherein the chlorine biocide compounds are selected from trichloroisocyanuric acid (TCCA) or sodium dichloroisocyanurate (NaDCC) or mixtures thereof.

18. The solid, shaped body of claim 15, wherein the chlorine biocide compound content of said final compacted solid, shaped body is between 10% and 80% by weight.

19. The solid, shaped body of claim 18, wherein the chlorine biocide compound content is between 20% and 40% by weight.

20. The solid, shaped body of claim 15, wherein the weight of the tablet is between about 10 and 300 grams, and the breaking strength of said tablet is above 16 lbs.

21. The solid, shaped body of claim 15, wherein the weight of the tablet is between about 20 and 100 grams and the breaking strength of said solid, shaped body is in the range is above 16 lbs.

22. A compacted, solid, shaped body according to claim 14, containing a mixture of bromochlorodimethylhydantoin (BCDMH) and trichloroisocyanuric acid (TCCA) or sodium dichloroisocyanurate (NaDCC) or mixtures thereof, said BCDMH content in said body being about 67.5 wt %, and said TCCA or said NaDCC or mixtures thereof content in said body being about 32.5 wt %, said body weight being about 100 grams or more and said body's breaking strength being above 16 lbs.

23. A compacted, solid, shaped body according to claim 14, containing a mixture of bromochlorodimethylhydantoin (BCDMH) and trichloroisocyanuric acid (TCCA) or sodium dichloroisocyanurate (NaDCC) or mixtures thereof, wherein the BCDMH content in said body is about 80 wt %, the TCCA or NaDCC content in said body is about 20 wt %, the weight of the body is about 100 grams or more and the breaking strength of the body is above 16 lbs.

24. A compacted, solid, shaped body according to claim 14, containing a mixture of 1-bromo-3-chloro-5,5-dimethylhydantoin (BCDMH) and trichloroisocyanuric acid (TCCA) or sodium dichloroisocyanurate (NaDCC) or mixtures thereof, wherein the BCDMH content in said body is about 70 wt %, the TCCA or NaDCC or mixtures thereof content in said tablet is about 30 wt %, and the solid, shaped body has an oxidizing power as chlorine of about 67% for TCCA and of about 57% for NaDCC.

25. A compacted solid, shaped body according to claim 14, containing a mixture of 1,3-dibromo-5,5-dimethylhydantoin (DBDMH) and trichloroisocyanuric acid (TCCA) or sodium dichloroisocyanurate (NaDCC), wherein the DBDMH content in said body is about 70 wt %, the TCCA or NaDCC or mixtures thereof content in said body is about 30 wt %, and said body has an oxidizing power as chlorine of about 62% for TCCA and of about 51% for NaDCC.

26. The solid, shaped body of claim 25, wherein the weight of said body is about 20 grams or less and its breaking strength is above 16 lbs.

27. The solid, shaped body of claim 25, wherein the weight of said body is between about 20 and 100 grams and its breaking strength is above 16 lbs.

28. The solid, shaped body of claim 25, wherein the weight of said body is between about 20 and 100 grams and its breaking strength is in the range of between 20.5 lbs and 24.5 lbs

29. The solid, shaped body of claim 25, wherein the weight of said body is between about 20 and 100 grams and its breaking strength is in the range of between 18.5 lbs and 22.8 lbs.

30. (canceled)

31. (canceled)

32. The shaped body of claim 14, which is in the form of briquettes, wafers, tablets and sticks or the like, in various dimensions and weights.

33. A method of disinfecting aqueous media, comprising adding to said media a solid, shaped composition or body as claimed in claim 14.

34. A method according to claim 31, wherein the aqueous medium is selected from the group consisting of industrial water, waste water, pulp & paper industry water, cooling towers, pools, spas, institutional application, and domestic application.
